(19) United States
(12) Patent Application Publication
(10) Pub. No.: US 2025/0180840 A1
(43) Pub. Date: Jun. 5, 2025

(54) TEARABLE LUMEN FOR USE IN HIGH FIBER DENSITY OPTICAL FIBER CABLE

(71) Applicant: CORNING RESEARCH & DEVELOPMENT CORPORATION, Corning, NY (US)

(72) Inventors: Anna Lipiec, Lodz (PL); Malgorzata Wojtczak-Michalska, Lodz (PL)

(21) Appl. No.: 19/046,876

(22) Filed: Feb. 6, 2025

Related U.S. Application Data
(63) Continuation of application No. PCT/US2023/029259, filed on Aug. 2, 2023.
(60) Provisional application No. 63/397,066, filed on Aug. 11, 2022.

(51) Int. Cl. G02B 6/44

(52) U.S. Cl. CPC G02B 6/441

(57) ABSTRACT

Provided are embodiments of a lumen. The lumen includes a plurality of optical fibers and a membrane surrounding the plurality of optical fibers. A thickness of the membrane is 80 microns or less, and a free space within the membrane is 50% or less. Further, the membrane has a tear strength of 10 mN/mm or less as measured according to ASTM D1938-19. A plurality of such lumens can be combined together to form a cable core around which a cable jacket is extruded to provide a high fiber density optical fiber cable.

### CROSS-REFERENCE TO RELATED APPLICATIONS

This application is a continuation of Internation Application No. PCT/US2023/029259, filed on Aug. 2, 2023, which claims the benefit of priority of U.S. Provisional Application Ser. No. 63/397,066 filed on Aug. 11, 2022, the content of which is relied upon and incorporated herein by reference in its entirety.

### BACKGROUND OF THE DISCLOSURE

The present disclosure generally relates to optical fiber cables and in particular to optical fiber cables having a high density of optical fibers and minimized free space.

In general, an optical fiber cable needs to carry more optical fibers in order to transmit more optical data, and in order to carry more optical fibers, the size of the optical fiber cable conventionally needed to be increased. The increased size is at least partially the result of free space considerations to avoid macro- and micro-bending attenuation losses. For existing installations, size limitations and duct congestion limit the size of optical fiber cables that can be used without the requirement for significant retrofitting. Thus, it may be desirable to provide optical fiber cables having a higher fiber density (i.e., more fibers per cross-sectional area of the cable) without increasing the cable diameter such that the high fiber density cables can be used in existing ducts.

### SUMMARY OF THE DISCLOSURE

In one aspect, embodiments of the present disclosure relate to a lumen. The lumen includes a plurality of optical fibers and a membrane surrounding the plurality of optical fibers. A thickness of the membrane is 80 microns or less, and a free space within the membrane is 50% or less. Further, the membrane has a tear strength of 10 mN/mm or less as measured according to ASTM D1938-19.

In another aspect, embodiments of the present disclosure relate to an optical fiber cable. The optical fiber cable includes a cable jacket having an inner surface and an outer surface. The inner surface defines a central bore extending along a longitudinal axis of the optical fiber cable, and the outer surface defines an outermost surface of the optical fiber cable. A plurality of lumens are disposed within the central bore. Each lumen of the plurality of lumens is made up of a plurality of optical fibers surrounded by a membrane. The membrane has a thickness of 80 microns or less, and the membrane has a tear strength of 10 mN/mm or less as measured according to ASTM D1938-19. Further, the plurality of optical fibers of the plurality of lumens comprises a cumulative tensile rigidity of at least 75% of a tensile rigidity of the optical fiber cable.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiments, and together with the description serve to explain principles and operation of the various embodiments. In the drawings:

FIG. 1 depicts a perspective view of a high fiber density optical fiber cable, according to exemplary embodiments; and

FIG. 2 depicts a flow diagram of a method of forming a high fiber density optical fiber cable, according to exemplary embodiments.

### DETAILED DESCRIPTION

Embodiments of the present disclosure relate to a tearable lumen for use in a high fiber density optical fiber cable. In order to fit more optical fibers within a cable while maintaining the same cable size and providing fiber organization, the optical fibers can be arranged in lumens comprised of groups of optical fibers surrounded by thin membranes. To provide accessibility to the optical fibers in the lumens without the need for specialized equipment, the lumens according to the present disclosure are tearable by hand. The inventors have found that the property of being tearable by hand relates in part to the thickness of the membrane but also to the composition of the membrane. In particular, it was determined that a highly filled polymer composition was able to provide a balance between lumen strength, lumen processability, and lumen accessibility. These and other aspects and advantages of the disclosed tearable lumen for high fiber density optical fiber cables will be described in greater detail below and in relation to the accompanying figures. These exemplary embodiments are provided by way of illustration, and not by way of limitation.

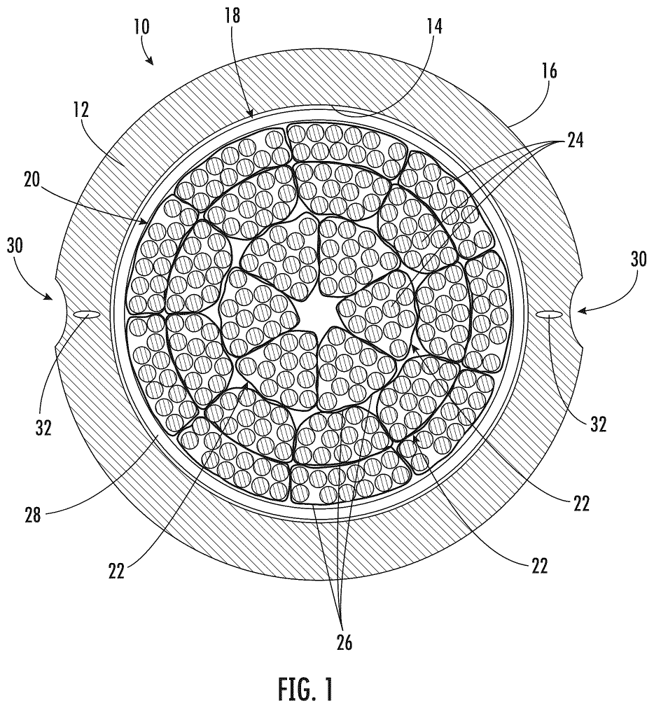

FIG. 1 depicts an example embodiment of a high fiber density optical fiber cable 10. The optical fiber cable 10 includes a cable jacket 12 having an inner surface 14 and an outer surface 16. The inner surface 14 of the optical fiber cable 10 defines a central bore 18 that extends along the longitudinal axis of the optical fiber cable 10. Disposed within the central bore 18 of the optical fiber cable 10 is cable core 20 including a plurality of subunits referred to herein as “lumens” 22. The lumens 22 each include a plurality of optical fibers 24 surrounded by a membrane 26. The membrane 26 is a thin and flexible sheath that allows for the lumen 22 to be reconfigured into a variety of different shapes. In this way, the lumens 22 can be densely packed within the cable core 20 by changing shape, e.g., flattening out, bunching up, or bending, as necessary to fill space within the cable core 20.

In one or more embodiments, the interior surface of the membrane 26 defines an interior cross-sectional area of the lumen 22. The portion of this interior cross-sectional area that is not occupied by the optical fibers 24 is referred to as “free space.” In one or more embodiments, each lumen 22 comprises a free space of 50% or less, 40% or less, 30% or less, or 25% or less. In one or more embodiments, each lumen 22 comprises a free space of 20% or more. Not only does the low free space within the lumens 22 provide a high fiber density for the optical fiber cable 10, but also, the low free space mechanically couples the optical fibers 24 together such that the optical fibers 24 act as a composite strength element within the optical fiber cable 10. In this way, the cable core 20 does not include any additional strength elements, such as glass reinforced plastic rods, steel wires, or tensile strands (e.g., aramid or glass yarns).

In one or more embodiments, the optical fibers 24 take up at least 75%, at least 80%, at least 85%, at least 90%, or at least 95% of the tensile load on the optical fiber cable 10. The amount of tensile load taken up by the optical fibers 24 can be represented by the ratio of tensile rigidity of the optical fibers 24 to the tensile rigidity of the optical fiber cables 10. The tensile rigidity of the optical fibers 24 is the elastic modulus (E) of the optical fibers 24 multiplied by their cumulative cross-sectional area (A) within the optical fiber cable 10. The cumulative cross-sectional area of the optical fibers 24 is the sum of the cross-sectional area of each optical fiber 22 based on the outer diameter of the optical fibers 24. The tensile rigidity of the optical fiber cable 10 is the sum of the products of the clastic moduli (E) of each component of the optical fiber cable 10 multiplied by the component's cross sectional area (A) or cumulative cross-sectional area (A).

In one or more embodiments, the optical fibers 24 comprise a tensile rigidity of at least 30,000 N, at least 35,000 N, or at least 40,000 N for an optical fiber cable 10 having 48 optical fibers 24 and a tensile rigidity of 50,000 N or less. In one or more embodiments, the optical fibers 24 comprise a tensile rigidity of at least 60,000 N, at least 70,000 N, or at least 80,000 N for an optical fiber cable 10 having 96 optical fibers 24 and a tensile rigidity of 100,000 N or less. In one or more embodiments, the optical fibers 24 comprise a tensile rigidity of at least 120,000 N, at least 140,000 N, or at least 160,000 N for an optical fiber cable 10 having 192 optical fibers 24 and a tensile rigidity of 180,000 N or less. In one or more embodiments, the optical fibers 24 comprise a tensile rigidity of at least 175,000 N, at least 200,000 N, or at least 225,000 N for an optical fiber cable 10 having 288 optical fibers 24 and a tensile rigidity of 300,000 N or less. In one or more embodiments, the optical fibers 24 comprise a tensile rigidity of at least 250,000 N, at least 280,000 N, or at least 310,000 N for an optical fiber cable 10 having 384 optical fibers 24 and a tensile rigidity of 350,000 N or less. In one or more embodiments, the optical fibers 24 comprise a tensile rigidity of at least 300,000 N, at least 350,000 N, or at least 400,000 N for an optical fiber cable 10 having 480 optical fibers 24 and a tensile rigidity of 450,000 N or less. In one or more embodiments, the optical fibers 24 comprise a tensile rigidity of at least 375,000 N, at least 425,000 N, or at least 475,000 N for an optical fiber cable 10 having 576 optical fibers 24 and a tensile rigidity of 550,000 N or less.

In one or more embodiments, the optical fibers 24 of the optical fiber cable 10 have the highest elastic modulus of any component in the optical fiber cable 10. In one or more such embodiments, no component in the optical fiber cable 10 besides the optical fibers 24 has a modulus higher than 48 GPa, higher than 40 GPa, higher than 30 GPa, or higher than 25 GPa.

In one or more embodiments, the optical fibers 24 of the cable core 20 of the optical fiber cable 10 comprise at least 50%, at least 60%, at least 70%, at least 75%, at least 80%, at least 85%, at least 90%, or at least 95% of the bending stiffness of the optical fiber cable 10. In an example embodiment, an optical fiber cable 10 having 288 optical fibers 24 organized into lumens 22 exhibited a bending stiffness of 0.51 N·m². The lumens 22 were organized into three layers within the cable core 20 of the optical fiber cable 10 (e.g., as shown in FIG. 1). Of the bending stiffness, the optical fibers 24 accounted for about 0.50 N·m² with the cable jacket 12 accounting for the rest.

As discussed above, the lumens 22 may be stranded (such as SZ-stranded) in the cable core 20 in embodiments, including a binder 28 provided around switchbacks and the full length of the cable core 20. The stranding provides the ability to bend the cable while minimizing tensile and contractive forces within any of the fibers. During cable bending, the optical fibers 24 must be able to shift position, moving longitudinally to relieve those forces so as not to cause attenuation or break the optical fibers 24. Because the membranes 26 and cable core 20 do not provide free space for the optical fibers 24 to increase fiber density by design, the lumens 22 may be configured to move relative to each other in certain embodiments by using solid or gel lubricants, such as talc, or using water-absorbing powders.

Thus, in one or more embodiments, the optical fiber cable 10 may consist essentially of the cable jacket 12 surrounding a plurality of lumens 22. Other components that do not affect the basic and novel characteristics of the optical fiber cable 10 that may be included are, for example, a binder 28 provided between the plurality of lumens 22 and the cable jacket 12, water blocking material (e.g., tapes and powders), lubricants, friction-enhancing materials, and access features (e.g., ripcords or preferential tear features, such as a strip of dissimilar polymer in the cable jacket 12). In one or more embodiments, armor layers and strength elements are excluded from the construction of the optical fiber cable 10.

In one or more embodiments, the thickness of the membrane 26 is 80 microns or less, 70 microns or less, 60 microns or less, 50 microns or less, 40 microns or less, or 30 microns or less. In one or more embodiments, the thickness of the membrane 26 is at least 10 microns or at least 20 microns. In one or more embodiments, the membrane 26 has a thickness in a range from 10 microns to 80 microns, 10 microns to 70 microns, 10 microns to 60 microns, 10 microns to 50 microns, 10 microns to 40 microns, 10 microns to 30 microns, 10 microns to 20 microns, 20 microns to 80 microns, 20 microns to 70 microns, 20 microns to 60 microns, 20 microns to 50 microns, 20 microns to 40 microns, or 20 microns to 30 microns, 30 microns to 80 microns, 30 microns to 70 microns, 30 microns to 60 microns, 30 microns to 50 microns, 30 microns to 40 microns, 40 microns to 80 microns, 40 microns to 70 microns, 40 microns to 60 microns, 40 microns to 50 microns, 50 microns to 80 microns, 50 microns to 70 microns, 50 microns to 60 microns, 60 microns to 80 microns, 60 microns to 70 microns, or 70 microns to 80 microns. In one or more embodiments, the membrane 26 groups from two to ninety-six in particular from eight to thirty-six, and particularly from twelve to twenty-four, optical fibers 24 into a lumen 22.

In one or more embodiments, the lumens 22 are surrounded by a binder 28. In one or more embodiments, the binder 28 is a thin film jacket having a thickness between 40 microns and 150 microns. In such embodiments, the binder 28 having a thickness in this thickness range reduces the thermal load of the binder 28 on the lumens 22 during extrusion. That is, a thick binder layer could hold enough heat after extrusion to degrade the thin membranes 26 of the lumens 22. In one or more embodiments, the binder 28 is made from, e.g., linear low density polyethylene (LLDPE).

In one or more embodiments, the cable jacket 12 has a thickness of between 0.5 mm and 1 mm. In particular embodiments, the cable jacket 12 has a thickness that is from 8% to 10% of the outer diameter of the optical fiber cable 10. In one or more embodiments, the cable jacket 12 is made from a polyethylene material (such as high density polyethylene (HDPE)), a low-smoke zero halogen (LSZH) polymer, a filled polyethylene, a flame retardant (FR) polymer, or a urethane polymer, amongst other possibilities.

In one or more embodiments, the cable jacket 12 includes tactile locator features 30. In the embodiment depicted, the tactile locator features 30 comprise diametrically arranged depressions defined by the outer surface 16 of the cable jacket 12. However, in one or more other embodiments, the tactile locator features 30 comprise diametrically arranged bumps defined by the outer surface 16 of the cable jacket 12. The tactile locator features 30 assist a user in opening the cable 10 by guiding the user to the location of access features 32. In the embodiment of the optical fiber cable 10, the access features 32 are strips of dissimilar polymer embedded in the polymer of the cable jacket 12. For example, the cable jacket 12 may substantially comprise polyethylene, and the dissimilar polymer of the access feature 32 may be polypropylene. The immiscibility of polyethylene cable jacket 12 and the polypropylene access features 32 prevents a strong bond from forming between the cable jacket 12 and the access features 32, allowing for a user to tear through the cable jacket 12 in the region of the access features 32. Further, once opened at the access features 32, the cable jacket 12 can be split along its length along the access features 32.

In one or more embodiments, the optical fiber cable 10 includes from 48 to 576 optical fibers 24, in particular from 96 to 288 optical fibers 24. In one or more embodiments, the optical fiber cable 10 has a fiber density of at least 7.5 fibers/mm². The fiber density is measured based on the number of optical fibers 24 per cross-sectional area of the optical fiber cable 10 as measured from the outer surface 16. In one or more embodiments, the fiber density is at least 8 fibers/mm², at least 8.5 fibers/mm², at least 9 fibers/mm², at least 9.5 fibers/mm², at least 10 fibers/mm², at least 10.5 fibers/mm², at least 11 fibers/mm², at least 11.5 fibers/mm², or at least 12 fibers/mm². In one or more embodiments, the fiber density may be up to 17 fibers/mm². Further, in one or more embodiments, the outer diameter of the optical fiber cable 10 as measured at the outer surface 16 is 9 mm or less, 8.5 mm or less, 8 mm or less, 7.5 mm or less, 7 mm or less, 6.75 mm or less, 6.5 mm or less, 6.25 mm or less, 6 mm or less, 5.75 mm or less, 5.5 mm or less, 5.25 mm or less, or 5 mm or less. Further, in one or more embodiments, the outer diameter of the optical fiber cable 10 as measured from the outer surface 16 is at least 2 mm.

In one or more embodiments, the optical fiber cable 10 has a cumulative fiber filling coefficient of at least 50%, at least 60%, at least 65%, or at least 70%. In one or more embodiments, the optical fiber cable 10 has a cumulative fiber filling coefficient of up to 85%. As used herein, the term “cumulative fiber filling coefficient” of an optical-fiber cable 10 refers to the ratio of the sum of the cross-sectional areas of all of the optical fibers 24 within the optical-fiber cable 10 versus the inner cross-sectional area of the optical-fiber cable 10 (i.e., defined by the inner surface 14 of the cable jacket 12 or inner surface of binder 28, if included). The cross-sectional area of each optical fiber 24 is determined based on an outer surface of the optical fiber 24.

In one or more embodiments, the optical fiber cable 10 comprises a free space of at most 50%, at most 42.5%, at most 30%, or at most 25%. In one or more embodiments, the free space of the optical fiber cable 10 is at least 15%. As used herein, the free space is the inverse of cumulative fiber filling coefficient (i.e., 100%-cumulative fiber filling coefficient).

According to embodiments of the present disclosure, the lumens 22 comprise a membrane 26 that is configured to be finger-tearable without damaging the optical fibers 24 within the lumen 22. This property relates to the ability of an installer to access the optical fibers 24 within the lumen 22 without the need for specialized equipment and without damaging the optical fibers 24. While the thickness of the membrane 26 is an important factor affecting the tearability of the lumen 22, the inventors have determined that providing a membrane 26 with a desired thickness alone is not sufficient to provide consistent tearability without damaging the optical fibers 24.

In particular, the inventors experimented with several different materials of the membrane 26 to determine the tearability of the membrane 26. Specifically, the inventors extruded membranes of linear low density polyethylene (LLDPE, DOWLEX™ 2247G, available from The Dow Chemical Company, Midland, MI), polypropylene impact copolymer (PPC, pp 1121, available from Borealis AG, Vienna, Austria), and heteropolymer polypropylene (PP, Achieve™ Advanced pp 3854 available from Exxon Mobil Corporation, Irving, TX) around optical fibers to form lumens. The LLDPE and PPC membranes had membranes having a thickness greater than 20 μm, and it was not possible to open the membranes without breaking at least some of the optical fibers within the lumen. The PP membrane was able to be extruded at a thickness of about 20 μm, but it was still not possible to consistently open the lumens without breaking optical fibers.

In view of the performance of the tested polymers, the inventors investigated the performance of a highly filled polymer composition as a membrane 26 of the lumen 22. In particular, the inventors determined that certain highly filled polymer compositions were able to be extruded at the desired membrane thickness and were able to be torn by hand without breaking the optical fibers 24. In one or more embodiments, the composition of the membrane 26 includes at least a polymer component and a filler component. In one or more embodiments, the polymer component comprises polypropylene. In one or more embodiments, the filler component comprises magnesium dihydroxide and/or aluminum trihydrate. In one or more embodiments, the filler component comprises particles having a maximum cross-sectional dimension that is less than the thickness of the membrane 26. In one or more embodiments, the filler component comprises particles having a maximum cross-sectional dimension that is 50 μm or less, 40 μm or less, 30 μm or less, 20 μm or less, or 10 μm or less. In one or more embodiments, the particles of the filler component have a maximum cross-sectional dimension of at least 0.25 μm, at least 0.5 μm, or at least 1 μm.

In one or more embodiments, the polymer composition of the membrane 26 comprises at least 60% by weight of the filler component, at least 65% by weight of the filler component, at least 70% by weight of the filler component, at least 75% by weight of the filler component, or at least 80% by weight of the filler component. In one or more embodiments, the polymer component comprises the balance the polymer composition, e.g., up to 20% by weight of the polymer component, up to 25% by weight of the polymer composition, up to 30% by weight of the polymer component, up to 35% by weight of the polymer component, or up to 40% by weight of the polymer component. In one or more embodiments, the polymer composition comprises other additives including various processing and performance aids, colorants, or compatibilizers, among others.

In one or more embodiments, the polymer composition of the membrane 26 includes a liquid colorant. Such liquid colorants typically include smaller colorant particles, which facilitates extrusion of a membrane 26 that is substantially free of defects. In one or more embodiments, the lumens 22 within the optical fiber cable 10 are color coded according to one or more industry-accepted schemes, such as the twelve-color scheme of blue, orange, green, brown, slate, white, red, black, yellow, violet, rose, and aqua. In embodiments of the optical fiber cable 10 having more than twelve lumens 22, the color-coding sequence may be repeated with the second and subsequent sets of twelve lumens including ring markings, machine readable codes, or identifier markings printed onto the membranes 26. It should be noted that the particular color-coding sequence described is merely exemplary, and other color sequences can be used instead without departing from the scope of the present disclosure.

In one or more embodiments, the composition of the membrane 26 has a density in a range from 1.4 to 1.46 g/cm³ as measured according to ISO 1183. In one or more embodiments, the composition of the membrane 26 has a melt flow index of 3 g/10 min to 5 g/10 min as measured at 230° C. and 5 kg according to PN-EN ISO 1133:2006. In one or more embodiments, the composition of the membrane 26 has a Shore D hardness of at least 60 as measured according to DIN 53505. In one or more embodiments, the polymer composition of the membrane 26 has a tensile strength in a range of 5 MPa to 25 MPa, in particular 7 MPa to 15 MPa, as measured according to IEC 60811-501. In one or more embodiments, the polymer composition of the membrane 26 has an elongation at break of 100% to 500%, in particular 200% to 300%, as measured according to IEC 60811-501. The foregoing properties represent a balance between lumen processibility, lumen strength, and lumen accessibility. A commercially available composition satisfying the foregoing criteria is CONGuard FR PP 0516 from Condor Compounds GmbH, Braunschweig Germany.

In one or more embodiments, the composition of the membrane 26 has a tear strength of 10 mN/mm or less, 7 mN/mm or less, or 5 mN/mm or less as measured according to ASTM D1938-19 for membranes 26 having a thickness of 100 microns or less. In one or more embodiments, the tear strength is 0.1 mN/mm or greater, 0.25 mN/mm or greater, 0.5 mN/mm or greater, or 1 mN/mm or greater as measured according to ASTM D1938-19 for membranes 26 having a thickness of 100 microns or less. A membrane 26 having a tear strength as described will be sufficiently handleable for carrying optical fibers while also providing for the desired finger-tearability without damaging the optical fibers.

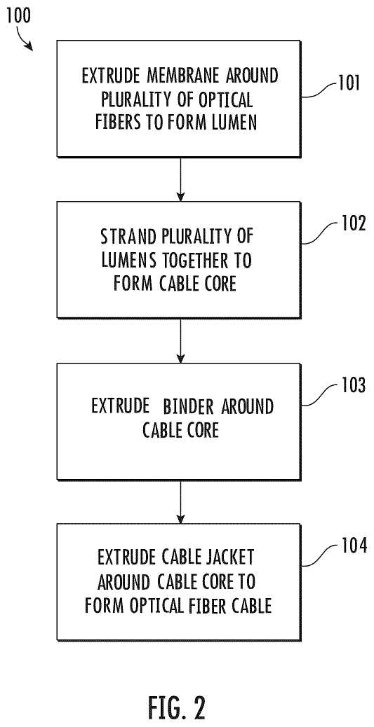

Having described the optical fiber cable 10, embodiments of a method for manufacturing an optical fiber cable 10 including a plurality of lumens 22 will be described in relation to the flow diagram of FIG. 2. In one or more embodiments, a method 100 of forming the lumens 22 involves extruding the membrane 26 around the plurality of optical fibers 24 in a first step 101. In one or more embodiments, the membrane 26 may be extruded around the optical fibers 24 while the optical fibers 24 are in a 3×4 rectangular or offset rectangular arrangement or a 2×6 rectangular or parallelogram arrangement. In these initial configurations, the lumens 22 may be able to more easily shift to the various space-saving configurations, such as those shown in FIG. 1, to provide a high fiber density optical fiber cable 10.

In one or more embodiments of the method 100, the lumens 22 are formed into a cable core 20 in a second step 102. In embodiments, the lumens 22 extend straight along the longitudinal axis in the cable core 20, and in other embodiments, the lumens 22 are stranded (e.g., S-stranded, Z-stranded, or SZ-stranded) along the longitudinal axis in the cable core 20.

In one or more embodiments of the method 100, the binder 28 is optionally extruded around a plurality of lumens 22 in a third step 103. In a fourth step 104 of the method 100, a cable jacket 12 is then extruded around the lumens 22 or binder 28, as the case may be. During extrusion of the cable jacket 12, the access feature 32 and the tactile locator features 30 may be formed in the cable jacket 12 through the use of specially-configured extrusion die-heads. A vacuum may be pulled during extrusion of the cable jacket 12, which squeezes the cable jacket 12 down around the lumens 22. Additionally or alternatively, the cable jacket 12 can be made thicker, which results in greater shrinkage during cooling, compressing the lumens 22. Advantageously, by compressing the cable jacket 12 around the lumens 22, the individual lumens 22 may be manufactured with a higher than desired free space, and the force of the cable jacket 12 on the lumens 22 in the cable core 20 can reconfigure the lumens 22 into shapes with lower free space within the optical fiber cable 10.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A routable base unit (RBU), comprising
a plurality of optical fibers;
a membrane surrounding the plurality of optical fibers;
wherein a thickness of the membrane is 80 microns or less;
wherein a free space within the membrane is 50% or less; and
wherein the membrane has a tear strength of 10 mN/mm or less as measured according to ASTM D1938-19.

2. The RBU of claim 1, wherein the membrane comprises a polymer composition comprising a polymer component and a filler component and wherein the filler component is at least 60% by weight of the polymer composition.

3. The RBU of claim 2, wherein the filler component comprises at least one of magnesium dihydroxide or aluminum trihydrate.

4. The RBU of claim 2, wherein the filler component comprises a plurality of particles and wherein the particles each have a maximum cross-sectional dimension that is less than the thickness of the membrane.

5. The RBU of claim 2, wherein the polymer composition comprises polypropylene.

6. The RBU of claim 2, wherein the polymer composition comprises a density in a range from 1.40 to 1.46 g/cm³ as measured according to ISO 1183.

7. The RBU of claim 2, wherein the polymer composition has a melt flow index of 3 g/10 min to 5 g/10 min as measured at 230° C. and 5 kg according to PN-EN ISO 1133:2006.

8. The RBU of claim 2, wherein the polymer composition has a Shore D hardness of at least 60 as measured according to DIN 53505.

9. The RBU of claim 2, wherein the polymer composition has a tensile strength in a range of 5 MPa to 25 MPa as measured according to IEC 60811-501.

10. The RBU of claim 2, wherein the polymer composition has an elongation at break of 100% to 500% as measured according to IEC 60811-501.

11. The RBU of claim 1, wherein the thickness of the membrane is from 10 microns to 50 microns.

12. The RBU of claim 1, wherein the free space within the membrane is in a range from 20% to 40%.

13. An optical fiber cable, comprising:
a cable jacket comprising an inner surface and an outer surface, wherein the inner surface defines a central bore extending along a longitudinal axis of the optical fiber cable and the outer surface defines an outermost surface of the optical fiber cable;
a plurality of routable base units (RBUs) disposed within the central bore;
wherein each RBU of the plurality of RBUs comprises a plurality of optical fibers surrounded by a membrane;
wherein the membrane has a thickness of 80 microns or less;
wherein the membrane has a tear strength of 10 mN/mm or less as measured according to ASTM D1938-19; and
wherein the plurality of optical fibers of the plurality of RBUs comprises a cumulative tensile rigidity of at least 75% of a tensile rigidity of the optical fiber cable.

14. The optical fiber cable of claim 13, wherein the membrane comprises a polymer composition comprising a polymer component and a filler component and wherein the filler component is at least 60% by weight of the polymer composition.

15. The optical fiber cable of claim 14, wherein the filler component comprises at least one of magnesium dihydroxide or aluminum trihydrate.

16. The optical fiber cable of claim 14, wherein the polymer composition has a Shore D hardness of at least 60 as measured according to DIN 53505.

17. The optical fiber cable of claim 13, wherein a RBU free space within the membrane is in a range from 20% to 40%.

18. The optical fiber cable of claim 17, wherein a cable free space within the central bore is in a range from 15% to 50%.

19. The optical fiber cable of claim 13, wherein the outer surface of the cable jacket defines a cross-sectional area perpendicular to the longitudinal axis and wherein the optical fiber cable comprises a fiber density of at least 7.5 fibers/mm² as measured at the cross-sectional area.

20. The optical fiber cable of claim 13, wherein the plurality of optical fibers comprise a highest elastic modulus of any component in the optical fiber cable.
